(19) United States
(12) Patent Application Publication
(10) Pub. No.: US 2014/0172487 A1
(43) Pub. Date: Jun. 19, 2014

(54) SCHEDULE MANAGEMENT SYSTEM AND SCHEDULE MANAGEMENT PROGRAM

(71) Applicant: COEXIST CO., LTD., Hiroshima-ken (JP)

(72) Inventors: Yukihiko Takashiba, Hiroshima-ken (JP); Masahiko Tani, Hiroshima-ken (JP)

(73) Assignee: COEXIST Co., Ltd., Hiroshima-ken (JP)

(21) Appl. No.: 13/853,440

(22) Filed: Mar. 29, 2013

(30) Foreign Application Priority Data
Dec. 14, 2012 (JP) 2012-273752

(51) Int. Cl. G06Q 10/10

(52) U.S. Cl. CPC G06Q 10/1097
USPC 705/7.21

(57) ABSTRACT

A schedule management system comprises a long-term goal receive means; a long-term goal storage means for storing the long-term goals to be linked with the deadlines thereof; a mid-term goal receive means; a mid-term goal storage means for storing the mid-term goals to be linked with the deadlines thereof; a separate display means for separately displaying the mid-term goals and the daily tasks, in which the mid-term goals and daily tasks are respectively displayed separately in at least two categories depending on remaining time to the deadlines; and a mid-term-goal priority-sort means for sorting the separately displayed mid-term goals in the order of deadlines, and sorting the separately displayed daily tasks in the order of deadlines next to the mid-term goals displayed in the order of deadlines.

This application claims the benefit under 35 USC 119 of JP Patent Application JP 2012-273752 filed Dec. 14, 2012, the entire disclosure of which is incorporated herein by reference.

### BACKGROUND OF THE INVENTION

The present invention relates to a schedule management system and a schedule management program that are designed to sort daily tasks in an order of deadlines.

An increased number of people today manage their schedules with digital equipment such as personal computers and personal digital assistants, instead of ordinary datebooks.

In order to use the schedule management system with the digital equipment, a user inputs daily tasks and the deadlines thereof by which the daily tasks have to be finished, or inputs the daily tasks and the dates on which the daily tasks have to be carried out. When a daily schedule is displayed on a screen, the daily tasks input in the digital equipment are sorted and displayed in the order of deadlines (see, for example, the Japanese unexamined Patent Publication No. 2006-134343).

With the schedule management system introduced above, it is not necessary to display a calendar for showing a date of the deadline in several months and filling in the daily task to be carried out. This allows a speedy input of the daily task.

In addition, unlike the datebook, the digital equipment can display any particular entry in a large scale, which attracts the user and thus prevents an oversight of important entries.

Furthermore, although the screen of the digital equipment for displaying the list of daily tasks has a limited space like the datebook, the digital equipment can change a display on the screen with another display, such as from the list of the daily tasks to detailed information. Thus, much more information can be input in the digital equipment than in the datebook, and much more information can be checked from the digital equipment than from the datebook.

As described above, the schedule management system can manage daily tasks. However, the schedule management system is not designed to manage long-term goals (for example, “to start an independent business”) that are not easy to achieve.

Unlike the daily tasks, the long-term goals tend to allow people not to make an effort on a particular day for the goals, and the people receive only a little damage from not making an effort on a day or a next day, whereby they can postpone the effort. Thus, people in many cases fail to achieve the long-term goals prepared by themselves.

It is therefore an object of the present invention to provide a schedule management system and a schedule management program, with which users can manage the long-term goals as well as the daily tasks to readily achieve the long-term goals.

### SUMMARY OF THE INVENTION

In order to accomplish the above-mentioned object, a first aspect of the present invention provides a schedule management system (10) that comprises: a task receive means (11, 12) for receiving input of daily tasks to be finished on a daily basis and deadlines thereof; a task storage means (13) for storing the input daily tasks and deadlines thereof; in which the daily tasks are linked with the respective deadlines; a task sort means (11) for sorting the daily tasks in an order of deadlines; a long-term goal receive means (11, 12) for receiving input of long-term goals that are not easy to achieve and the deadlines thereof; a long-term goal storage means (13) for storing the input long-term goals and deadlines thereof, in which the long-term goals are linked with the respective deadlines; a mid-term goal receive means (11, 12) for receiving input of mid-term goals and the deadlines thereof to be set to achieve the long-term goals by the deadlines of the long-term goals; a mid-term goal storage means (13) for storing the input mid-term goals and deadlines thereof, in which the mid-term goals are linked with the respective deadlines; a separate display means (11) for displaying the mid-term goals separately from the daily tasks, wherein the mid-term goals are displayed in at least two categories depending on the remaining time to the deadlines, and the daily tasks are displayed in at least two categories depending on the remaining time to the deadlines; and a mid-term-goal priority-sort means (11) for sorting the separately displayed mid-term goals in the order of deadlines, and sorting the separately displayed daily tasks in the order of deadlines next to the mid-term goals displayed in the order of deadlines.

A second aspect of the present invention provides a schedule management system (10), wherein the system (10) of the first aspect further comprises a deadline priority sort means (11) for mixing the separately displayed mid-term goals and the daily tasks, and sorting them in the order of deadlines.

A third aspect of the present invention provides a schedule management system (10), wherein, in addition to the first or second system, the mid-term goals and the daily tasks are displayed with the deadlines thereof.

A fourth aspect of the present invention provides a schedule management system (10), wherein the schedule management system (10) of the first, second or third aspect further comprises a completion display means (11) for displaying number or ratio of finished items of the mid-term goals and the daily tasks.

A fifth aspect of the present invention provides a schedule management system (10), wherein, in addition to the first, second, third and fourth aspect, finished items of the mid-term goals and the daily tasks or items unfinished by the deadlines of the mid-term goals and the daily tasks is separately displayed.

A sixth aspect of the present invention provides a schedule management program for managing daily tasks to be finished on a daily basis together with long-term goals that are not easy to achieve, wherein the program comprises: a task receive step for receiving input of the daily tasks and deadlines thereof; a task storage step for storing the input daily tasks and deadlines thereof, in which the daily tasks are linked with the respective deadlines; a long-term goal receive step for receiving input of long-term goals and the deadlines thereof; a long-term goal storage step for storing the input long-term goals and deadlines thereof, in which the long-term goals are linked with the respective deadlines; a mid-term goal receive step for receiving input of mid-term goals and the deadlines thereof to be set to achieve the long-term goals by the deadlines of the long-term goals; a mid-term goal storage step for storing the input mid-term goals and deadlines thereof, in which the mid-term goals are linked with the respective deadlines; a separate display step for displaying the mid-term goals separately from the daily tasks, wherein the mid-term goals are displayed in at least two categories depending on the remaining time to the deadlines, and the daily tasks are displayed in at least two categories depending on the remaining time to the deadlines; and a mid-term-goal priority-sort step for sorting the separately displayed mid-term goals in the order of deadlines, and sorting the separately displayed daily tasks in the order of deadlines next to the mid-term goals displayed in the order of deadlines.

Symbols in parentheses show constituents or items corresponding to the drawings.

According to the schedule management system of the first aspect of the present invention, the mid-term goals to be set to achieve the long-term goals are displayed separately from the daily tasks, the mid-term goals are displayed separately in at least two categories depending on the remaining time to the deadlines, and the daily tasks are displayed separately in at least two categories depending on the remaining time to the deadlines. Thus, it becomes possible that a user can instantly distinguish between the mid-term goals and the daily tasks, and grasp each deadline in an approximate manner.

Furthermore, according to the schedule management system, the separately displayed mid-term goals are sorted in the order of the deadlines, and separately displayed daily tasks are sorted in the order of the deadlines next to the mid-term goals displayed in the order of the deadlines. This allows the user to recognize the mid-term goals before the daily tasks to be finished on a day. Accordingly, the user is provided with many occasions to recognize the long-term goals relating to the mid-term goals, and the user can set additional mid-term goals, which are relatively easy to finish, to achieve the long-term goals. As a result, the user can readily achieve the long-term goals by finishing the increased number of mid-term goals one by one.

According to the schedule management system of the second aspect of the present invention, the separately displayed mid-term goals and daily tasks are mixed together and are sorted in the order of deadlines. Thus, in addition to the advantageous effects of the first aspect of the present invention, it becomes possible that the user can recognize the mid-term goals and the daily tasks in the order of the deadlines, like a regular schedule management system.

According to the schedule management system of the third aspect, the mid-term goals and the daily tasks are displayed with the deadlines thereof. Thus, in addition to the advantageous effects of the first and second aspects of the present invention, it becomes possible that the user can instantly recognize the deadlines even though the mid-term goals and the daily tasks are not displayed in the order of deadlines.

According to the fourth aspect of the schedule management system, the number or the ratio of the items of the mid-term goals and the daily tasks already finished is displayed. Thus, in addition to the advantageous effects of the first, second and third aspects of the present invention, the user can survey schedule. Accordingly, if the number of finished mid-term goals and daily tasks is fewer than the desired number, this fact can be a guideline for the user to set an appropriate mid-term goals and daily tasks that the user can manage to finish.

According to the schedule management system of the fifth aspect, the items unfinished by the deadlines of the mid-term goals and the daily tasks are separately displayed. Thus, in addition to the advantageous effects of the first, second, third and fourth aspects of the present invention, it becomes possible to prevent, for example, neglect of returning a rental DVD or incomplete withdrawal of a credit card usage-charge due to insufficient funds in a bank account, which are the user's economical loss and loss of social reliability in a significant scale. In addition, separately displaying the finished items can reveal which items are unfinished.

According to the schedule management program of the sixth aspect of the present invention, the mid-term goals to be set to achieve long-term goals are displayed separately from the daily tasks, the mid-term goals are displayed separately in at least two categories depending on the remaining time to the deadlines, and the daily tasks are displayed separately in at least two categories depending on the remaining time to the deadlines. Thus, it becomes possible to instantly distinguish between the mid-term goals and the daily tasks, and grasp each deadline in an approximate manner.

Furthermore, with the use of the schedule management program, the separately displayed mid-term goals are sorted in the order of deadlines, and separately displayed daily tasks are sorted in the order of deadlines next to the mid-term goals displayed in the order of deadlines. This allows the user to recognize the mid-term goals before the daily tasks to be finished on the day. Accordingly, the user is provided with many occasions to recognize the long-term goals relating to the mid-term goals, so that the user can readily set additional mid-term goals to achieve the long-term goal. As a result, the user can achieve the long-term goals by finishing the increased number of mid-term goals one by one, which mid-term goals are relatively easy to finish.

It should be noted that the Japanese unexamined Patent Publication No. 2006-134343 does not disclose at all the features of displaying the mid-term goals relating the long-term goals separately from the daily tasks, and displaying the daily tasks sorted in the order of deadlines next to the mid-term goals sorted in the order of deadlines, unlike the schedule management system and the schedule management program of the present invention.

### BRIEF DESCRIPTION OF THE DRAWINGS

FIG. 1 is a block diagram showing a schematic electrical configuration of a schedule management system according to an embodiment of the present invention;

FIG. 2 is a flow chart showing a process of a control unit of the schedule management system according to the embodiment of the present invention;

FIG. 3 is an illustration of a screen displaying a list of long-term goals in the schedule management system according to the embodiment of the present invention;

FIG. 4 is an illustration of the screen displaying a list of mid-term goals and daily tasks in the schedule management system according to the embodiment of the present invention;

FIG. 5 is an illustration of the screen displaying a daily schedule in the schedule management system according to the embodiment of the present invention;

FIG. 6 is an illustration of the screen displaying a list of finished items in the schedule management system according to the embodiment of the present invention; and

FIG. 7 is an illustration of the screen displaying a list of mid-term goals and daily tasks in the schedule management system according to the embodiment of the present invention.

### DESCRIPTION OF PREFERRED EMBODIMENT

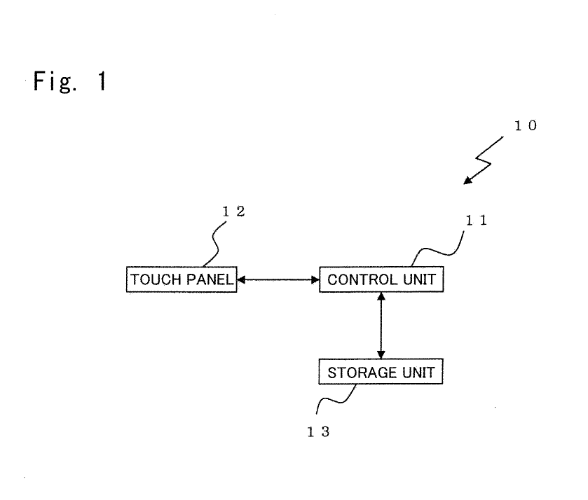

A schedule management system 10 and a schedule management program according to the present invention will be described below with reference to FIGS. 1 to 6.

The schedule management program is an application for use in a smartphone. The schedule management system 10 configures the smartphone in which the application is installed.

The schedule management program can manage long-term goals as well as daily tasks. Also, the schedule management program can manage mid-term goals.

The daily tasks refer to schedules to be finished with given time on a daily basis, and are relatively easy private and business matters.

Examples of the business tasks include “meetings”, “preparation of documents”, “serving customers”, “sales”, and “business trips”. The private tasks include, for example, “taking out recyclable garbage”, “going to lessons”, “going shopping”, “returning rental DVDs”, and “taking a child to the kinder garden”.

The long-term goals are ambitions that are not easy to achieve, and include personal life goals and dreams.

The long-term goals include not only a business matter but also a private matter, so that they may be multiple.

The business related long-term goals include, for example, “to become a shop manager”, “to achieve a sales norm”, “to reach an annual income of xx,xxx,xxx yen” and “to start an independent business”. Examples of privacy related long-term goals include “to get married”, “to have a home of my own”, “to become a good father”, and “to travel around the world”.

It is not necessary to separate the daily tasks and the long-term goals respectively into business relating items and privacy relating items. They are illustrated separately for explaining the daily tasks and the long-term goals.

The mid-term goals are small goals to be set to achieve a long-term goal by a deadline, and are set relative to each long-term goal by a user. In general, multiple mid-term goals are set for a single long-term goal. By appropriately finishing the mid-term goals, the possibility of achieving the long-term goal becomes higher.

Examples of the mid-term goals for a long-term goal “to achieve sales norm” include “to serve customers” and “to sale actively”, and the mid-term goals for the long-term goal “to become a store manager” include “to take a qualification test” and “to go to a cramming school for the qualification test”.

All the mid-term goals are not necessarily set and input at the time a long-term goal is set. The user can set additional mid-term goals while finishing previously set mid-term goals.

A schematic electrical configuration of the smartphone 10 according to an embodiment of the present invention will be described below with reference to FIG. 1.

The smartphone 10 includes a control unit 11, a touch panel 12 and a storage unit 13. The control unit 11 is designed to control an entire system in accordance with a control program stored in the storage unit 13. The control unit 11 comprises a CPU or a similar unit.

The touch panel 12 serves both as an input unit and a display screen. The touch panel 12 receives input of the daily tasks, the long-term goals and the like, and displays them on the screen.

The storage unit 13 comprises a storage medium including a ROM and a RAM. The storage unit 13 stores the control program that controls an entire system.

The storage unit 13 stores the daily tasks, the long-term goals and the like, which are input through the touch panel 12 and are linked with respective deadlines.

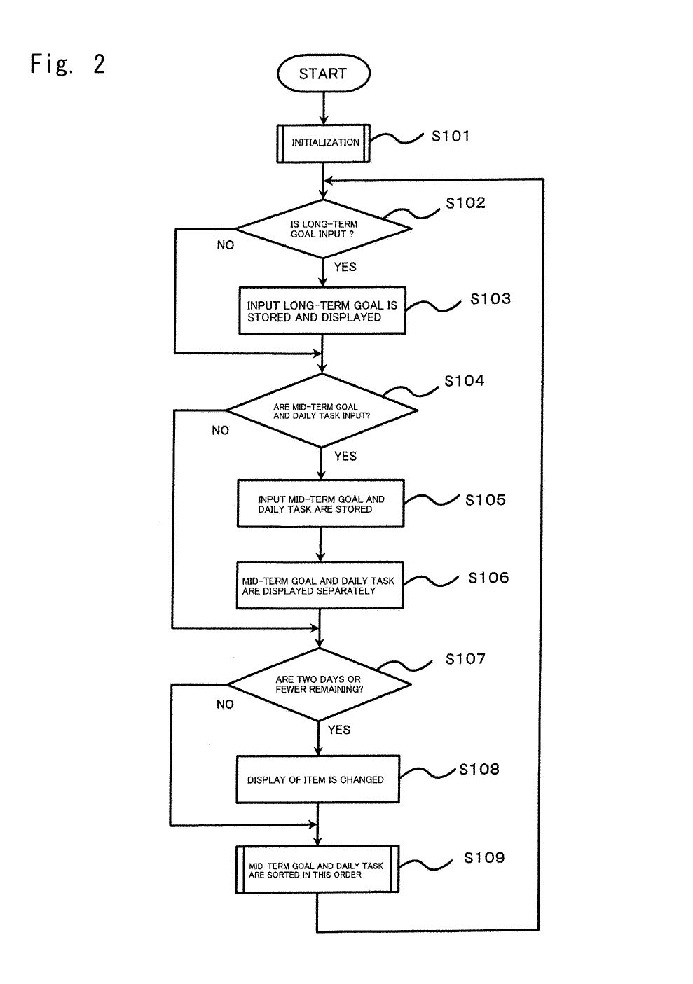

The control operated by the control unit 11 of the smartphone 10 in the schedule management system 10 as configured above will be described below with reference to a flowchart shown in FIG. 2.

First, the smartphone 10 is turned on to initialize the system (step S101 (hereinafter, the “step” will be omitted)). The initialization reads out daily tasks and other items stored in the storage unit 13 at the time the smartphone 10 is previously turned off, and displays them on the screen.

In this stage, a long-term goal and the deadline thereof is input (S102). Specifically, the user opens a screen exclusively for new input, and inputs the long-term goal and the deadline thereof on the screen.

After the long-term goal is input, the control unit 11 allows the storage unit 13 to store the input of the long-term goal and the deadline thereof, wherein the long-term goal is linked with the deadline thereof (S103).

The deadline of the long-term goal is not necessarily set and input at this time, and can be input thereafter. At the time the deadline of the long-term goal is input, the deadline is linked with the long-term goal.

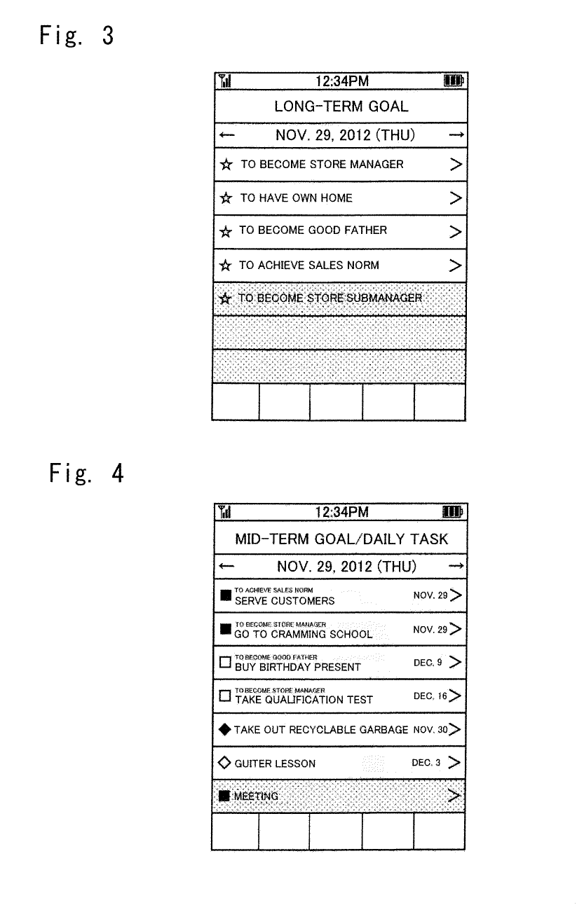

FIG. 3 shows a list of long-term goals. The long-term goals are displayed on the screen in the order of deadlines from the upper portion to the lower portion thereof. The long-term goal already achieved and checked by the user (in this embodiment, “to become a store sub-manager”) is displayed on a lower bottom of the screen with a gray-color background, separately from the remaining long-term goals that are not yet achieved.

Next, the control unit 11 receives the mid-term goals and the deadlines thereof as well as the daily tasks and the deadlines thereof (S104).

When the mid-term goals and the daily tasks are input, the control unit 11 allows the storage unit 13 to store them, in which each mid-term goal and daily task is linked with the corresponding deadlines (S105).

As is clear from the above description, this system is designed to receive input of the long-term goals, the mid-term goals and the daily tasks from the user in a parallel fashion.

The control unit 11 then displays the mid-term goals separately from the daily tasks (S106).

Furthermore, under the control of the control unit 11, the mid-term goals and the daily tasks are respectively made to correspond to remaining time to the deadlines (S107), and the mid-term goals and the daily tasks are displayed separately in at least two different categories respectively (S108).

In this embodiment, the mid-term goals and the daily tasks on a very day of or having one day for the deadlines are displayed in a different manner from the mid-term goals and the daily tasks having two or more days for the deadlines.

Then, the control unit 11 operates to sort the mid-term goals displayed in the separate manner into the order of deadlines, and sort the daily tasks displayed in the separate manner into the order of deadlines next to the mid-term goals sorted in the order of deadlines (S109).

After that, the process returns to S102, and receives input of another long-term goal, etc.

FIG. 4 shows a list of the mid-term goals and the daily tasks, which passed through the steps of S106 to S109.

In this list, the mid-term goals on the very day of or having one day for the deadlines are provided with the mark “▪ (black square)”, and the mid-term goals having two or more days for the deadlines are provided with the mark “□ (white square)”. In the same manner, the daily task on the very day of or having one day for the deadline is provided with the mark “♦ (black diamond)”, and the daily task having two or more days for the deadline is provided with the mark “⋄ (white diamond)”. Accordingly, the mid-term goals and the daily tasks are separated into a total of four categories. In addition, the mid-term goals and the daily tasks are displayed with their respective deadlines.

Moreover, each mid-term goal is provided with the corresponding long-term goal that is displayed above the mid-term goal with smaller letters so that it becomes instantly apparent which long-term goal each mid-term goal is set for.

The items already finished and checked by the user are displayed with the gray-color background (in this embodiment, “meeting”), and are separated from other items that are not yet achieved.

In this system, a tapping operation on each mid-term goal and daily task leads to another display (for example, a detailed information display).

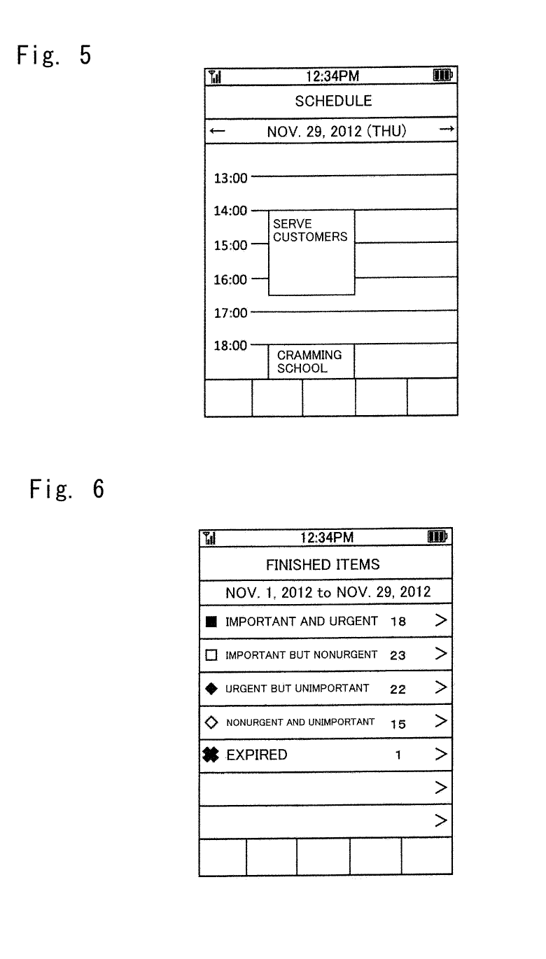

As shown in FIG. 5, the display showing a daily schedule is such that the mid-term goals and the daily tasks displayed in separate groups are mixed and sorted in the order of deadlines. More specifically, the mid-term goals and the daily tasks are sorted and displayed in accordance with the deadlines only, regardless whether the mid-term goals or the daily tasks, like an ordinary date book.

This display (FIG. 5) is linked with the display of the list of the mid-term goals and the daily tasks (FIG. 4). The mid-term goals and the daily tasks on the very day of the deadline are picked up from the mid-term goals and the daily tasks with the marks “▪ (black square)” and “♦ (black diamond)”. It is preferred that the “serving customers” and “cramming school” shown in FIG. 5 are provided with the mark “▪ (black square)”.

Although FIG. 5 shows a daily schedule, a weekly schedule or a monthly schedule can be displayed in the same manner.

FIG. 6 shows another screen displaying the number of finished mid-term goals and daily tasks in a designated period.

On this screen, the display of the mid-term goal on the very day of or having one day for the deadline is provided with the mark “▪ (black square)” and the description of “IMPORTANT AND URGENT”. The display of the mid-term goal having two or more days for the deadline is provided with the mark “□ (white square)” and the description “IMPORTANT BUT NONURGENT. The daily task on the very day of or having one day for the deadline is provided with the mark “♦ (black diamond)” and the description “URGENT BUT UNIMPORTANT”. Similarly, the display of the daily task having two or more days before the deadline is provided with the mark “⋄ (white diamond)” and the description “NONURGENT AND UNIMPORTANT”.

In the display described above, instead of the description “IMPORTANT AND URGENT”, a description “MID-TERM GOAL (URGENT)” may be displayed.

Furthermore, the mid-term goals and the daily tasks unfinished by the deadlines are provided with the mark “X” and a description “EXPIRED”.

According to the schedule management system 10 and the schedule management program having the configuration and the operation described above, the mid-term goals to be set to achieve the corresponding long-term goal are displayed separately from the daily tasks, the mid-term goals are displayed in at least two categories depending on the remaining time to the deadlines, and the daily tasks are displayed in at least two categories depending on the remaining time to the deadlines. Thus, it becomes possible that the user can instantly distinguish between the mid-term goals and the daily tasks, and grasp each deadline in an approximate manner.

Furthermore, in the schedule management system 10 and the schedule management program, the separately displayed mid-term goals are sorted in the order of deadlines, and separately displayed daily tasks are sorted in the order of deadlines next to the mid-term goals displayed in the order of deadlines. This allows the user to recognize the mid-term goals before the daily tasks to be finished on the day. Accordingly, the user is provided with many occasions to recognize the long-term goals relating to the respective mid-term goals, so that the user can set additional mid-term goals, which are relatively easy to finish, to achieve the long-term goals. As a result, the user can achieve the long-term goals by finishing the increased number of mid-term goals one by one.

Moreover, the mid-term goals and the daily tasks are displayed with their deadlines, so that it becomes possible for the user to instantly confirm the deadlines even though the mid-term goals and the daily tasks are not displayed in the order of deadlines.

Furthermore, as shown in FIG. 6, the number of mid-term goals and daily tasks already finished is displayed, and thus the user can survey the schedule. Accordingly, if the number of finished mid-term goals and daily tasks is less than the desired number, this fact can be a guideline for the user to set an appropriate number of mid-term goals and daily tasks that the user can surely finish.

Moreover, as shown in FIG. 4, the finished mid-term goals and daily tasks are displayed separately from the unfinished mid-term goals and daily tasks, thereby exposing which mid-term goals and daily tasks are unfinished.

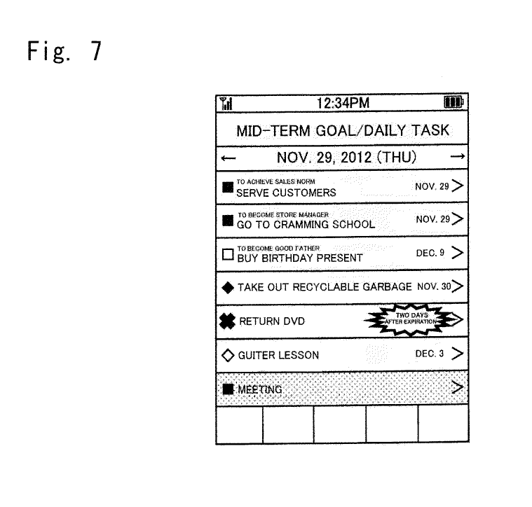

On the list of the mid-term goals and the daily tasks of the embodiment, the mid-term goals and the daily tasks expiring the deadlines are not displayed on the screen. But the mid-term goals and the daily tasks unfinished by the deadlines can be displayed separately, as shown in FIG. 7, with a striking color or flashing to attract attention most in the screen.

Such an arrangement can prevent, for example, neglect of returning a rental DVD or incomplete withdrawal of a credit card usage-charge due to insufficient funds in a bank account, which causes the user's economical loss and loss of social reliability in a significant scale.

In the description above, the number of the finished items of the mid-term goals and the daily tasks is displayed. But, instead of the number, the ratio of the finished mid-term goals and the daily tasks may be displayed.

Furthermore, the mid-term goals and the daily tasks displayed in a separate form are mixed and sorted in the order of deadlines, like an ordinary datebook (FIG. 5). The system including such a function is convenient.

In the above-mentioned embodiment, the mid-term goals and the daily tasks are displayed with their deadlines. But, the mid-term goals and the daily tasks can be displayed without the deadlines.

Furthermore, the marks provided on the mid-term goals and the daily tasks are determined based on whether the remaining time to the deadline is within two days or more. However, timing at which the marks are changed is not limited to the two days, and can be, for example, three days, or 48 hours.

The marks “▪ (black square)” and “♦ (black diamond)” are provided for distinguishing the mid-term goals from the daily tasks. The marks, however, are not limited to these and may be other icons. Also, each mark can be provided with its own color to differentiate from others. It is preferred that the mid-term goal closest to the deadline, which should be the most noticeable, is provided with a color such as red.

It should be noted that daily tasks and the long-term goals can be input in a personal computer and then imported to the schedule management system, as means for the input of the daily tasks.

Furthermore, the schedule management system can be synchronized with the date books on the cloud server to input the daily tasks, mid-term goals and long-term goals.

In the embodiment described above, the schedule management program is used as an application of the smartphone 10. The schedule management program can also be used in other programs including software of personal computers and personal digital assistants (digital equipment) such as PDA.

It should be noted that the steps of S106 to S109 are not necessarily carried out in this order. Thus, the steps can be performed in an order of S107, S108, S106 and S109, for example. What is important is that the user can see those steps as they are carried out at the same time.

We claim:

1. A schedule management system comprising:
a task receive means for receiving input of daily tasks to be finished on a daily basis and deadlines of the daily tasks;
a task storage means for storing the input the daily tasks and the deadlines of the daily tasks in which the daily tasks are linked with the respective deadlines;
a task sort means for sorting the daily tasks in the order of deadlines;
a long-term goal receive means for receiving input of long-term goals that are not easy to achieve and deadlines thereof;
a long-term goal storage means for storing the input the long-term goals and the deadlines of the long-term goals in which the long-term goals are linked with the deadlines;
a mid-term goal receive means for receiving the input of the mid-term goals and deadlines thereof to be set to achieve the long-term goals by the deadlines;
a mid-term goal storage means for storing the input the mid-term goals and the deadlines of the mid-term goals in which the mid-term goals are linked with the respective deadlines;
a separate display means for displaying the mid-term goals separately from the daily tasks, wherein the mid-term goals are displayed separately in at least two categories depending on the remaining time to the deadlines, and the daily tasks are displayed separately in at least two categories depending on the remaining time to the deadlines;
and a mid-term-goal priority-sort means for sorting the separately displayed mid-term goals in the order of deadlines, and sorting the separately displayed daily tasks in the order of deadlines next to the mid-term goals displayed in the order of deadlines.

2. The schedule management system as claimed in claim 1, wherein, the system further comprising a deadline priority sort means for mixing the separately displayed mid-term goals and the daily tasks, and sorting them in the order of deadlines.

3. The schedule management system as claimed in claim 1, wherein the mid-term goals and the daily tasks are displayed with the deadlines thereof.

4. The schedule management system as claimed in claim 2, wherein the mid-term goals and the daily tasks are displayed with the deadlines thereof.

5. The schedule management system as claimed in claim 1, wherein the schedule management system further comprising a completion display means for displaying number or ratio of finished items of the mid-term goals and the daily tasks.

6. The schedule management system as claimed in claim 2, wherein the schedule management system further comprising a completion display means for displaying number or ratio of finished items of the mid-term goals and the daily tasks.

7. The schedule management system as claimed in claim 3, wherein the schedule management system further comprising a completion display means for displaying number or ratio of finished items of the mid-term goals and the daily tasks.

8. The schedule management system as claimed in claim 4, wherein the schedule management system further comprising a completion display means for displaying number or ratio of finished items of the mid-term goals and the daily tasks.

9. The schedule management system as claimed in claim 1, wherein finished items of the mid-term goals and the daily tasks or items unfinished by the deadlines of the mid-term goals and the daily tasks is separately displayed.

10. The schedule management system as claimed in claim 2, wherein finished items of the mid-term goals and the daily tasks or items unfinished by the deadlines of the mid-term goals and the daily tasks is separately displayed.

11. The schedule management system as claimed in claim 3, wherein finished items of the mid-term goals and the daily tasks or items unfinished by the deadlines of the mid-term goals and the daily tasks is separately displayed.

12. The schedule management system as claimed in claim 4, wherein finished items of the mid-term goals and the daily tasks or items unfinished by the deadlines of the mid-term goals and the daily tasks is separately displayed.

13. The schedule management system as claimed in claim 5, wherein finished items of the mid-term goals and the daily tasks or items unfinished by the deadlines of the mid-term goals and the daily tasks is separately displayed.

14. The schedule management system as claimed in claim 6, wherein finished items of the mid-term goals and the daily tasks or items unfinished by the deadlines of the mid-term goals and the daily tasks is separately displayed.

15. The schedule management system as claimed in claim 7, wherein finished items of the mid-term goals and the daily tasks or items unfinished by the deadlines of the mid-term goals and the daily tasks is separately displayed.

16. The schedule management system as claimed in claim 8, wherein finished items of the mid-term goals and the daily tasks or items unfinished by the deadlines of the mid-term goals and the daily tasks is separately displayed.

17. A schedule management program for managing daily tasks to be finished on a daily basis and long-term goals that are not easy to be achieved, the program comprising:
a task receive step for receiving input of the daily tasks and deadlines thereof;
a task storage step for storing the input daily tasks and the deadlines thereof in which the daily tasks are linked with the respective deadlines;
a long-term goal receive step for receiving input of the long-term goals and the deadlines thereof;
a long-term goal storage step for storing the input long-term goals and the deadlines thereof in which the long-term goals are linked with the respective deadlines;
a mid-term goal receive step for receiving input of mid-term goals and the deadlines thereof to be set to achieve the long-term goals by the deadlines;
a mid-term goal storage step for storing the input mid-term goals and the deadlines thereof in which the mid-term goals are linked with the respective deadlines;
a separate display step for displaying the mid-term goals separately from the daily tasks, wherein the mid-term goals are displayed separately in at least two categories depending on the remaining time to the deadlines, and the daily tasks are displayed separately in at least two categories depending on the remaining time to the deadlines; and a mid-term-goal priority-sort step for sorting the separately displayed mid-term goals in the order of deadlines, and sorting the separately displayed daily tasks in the order of deadlines next to the mid-term goals displayed in the order of deadlines.
